(19) United States
(12) Patent Application Publication
(10) Pub. No.: US 2007/0141372 A1
(43) Pub. Date: Jun. 21, 2007

(54) Polypropylene multi-layer barrier films

(75) Inventors: Tien-Kuei Su, Saunderstown, RI (US); Keunsuk P. Chang, North Kingstown, RI (US)

Correspondence Address: MORRISON & FOERSTER LLP, 1650 TYSONS BOULEVARD, SUITE 400, MCLEAN, VA, 22102, US

(73) Assignee: TORAY PLASTICS (AMERICA), INC., N. Kingstown, RI (US)

(21) Appl. No.: 11/705,127

(22) Filed: Feb. 12, 2007

Related U.S. Application Data
(63) Continuation-in-part of application No. 10/954,023, filed on Sep. 30, 2004.
(60) Provisional application No. 60/507,090, filed on Oct. 1, 2003.

(51) Int. Cl. G11B 5/64; B32B 27/34; B32B 27/00

(52) U.S. Cl. 428/475.5; 428/336; 428/910; 428/500

(57) ABSTRACT

A biaxially oriented laminate film having a first skin layer of a blend of ethylene vinyl alcohol copolymer and amorphous nylon or nylon-containing ionomer; and a core layer comprising a blend of polypropylene resin and optionally an adhesion promoting resin that promotes adhesion between said blend and said polypropylene resin is disclosed. An intermediate layer could optionally be located between the first skin layer and the core layer, wherein the intermediate layer could have the adhesion promoting resin. The biaxially oriented laminate could optionally have a second skin layer such with the core layer between the first and second skin layers.

### RELATED APPLICATION

This application is a continuation-in-part of Ser. No. 10/954,203, filed Sep. 30, 2004, which is incorporated herein in its entirety by reference.

### FIELD OF INVENTION

This invention relates to a biaxially oriented metallized polypropylene film comprising a polyolefin core layer, a polar skin layer, and a metallized layer over the polar skin layer, which significantly improves oxygen, moisture, and flavor barrier, and metal adhesion, and a method of making the same.

### BACKGROUND OF INVENTION

Ethylene vinyl alcohol copolymers (EVOH) show excellent oxygen and flavor barrier properties at low humidity. However, its barrier property deteriorates dramatically under high humidity conditions. In fact, due to the polar nature of EVOH, such films made with EVOH generally exhibit poor moisture barrier. Therefore, EVOH is typically laminated with polyolefins on both sides to provide barrier properties for practical packaging applications in order to protect the EVOH from humidity effects. Moreover, EVOH is relatively brittle and difficult to stretch, tending to form cracks during stretching in biaxial orientation processes, for example.

DuPont's literature such as their data sheet for Selar® PA8072 reveals that blending amorphous nylons into EVOH improves processability and provides the product less moisture sensitivity. Amorphous nylons refer to those nylons that lack crystallinity. Suitable amorphous nylons can include hexamethylenediamine isophthalamide and terephthalamide. U.S. Pat. Nos. 5,208,082 and 5,286,575 which are incorporated herein by reference, teach blends of EVOH and amorphous nylon that provide barrier properties which are less humidity dependent and more thermally stable. However, although such compositions exhibit good oxygen barrier and are more stable, they are still deficient in terms of moisture barrier and prone to difficulties in biaxial orientation processes.

DuPont data sheets for their products such as Surlyn® AD1014 reveal that their nylon-containing ionomers improve flex resistance, toughness, and processability/orientability of EVOH. However, not all ionomers are the same. The nylon-containing ionomers have better compatibility with EVOH than those ionomers without nylon. U.S. Pat. No. 6,011,115, cited here for reference describes that nylon-containing ionomers in EVOH provide better haze, gloss, and impact resistance than their counterparts without nylon. U.S. Pat. No. 5,877,257 which is incorporated herein by reference, teaches us a blend of ethylene alcohol copolymer, crystalline nylon, and ionomers and optionally amorphous nylon. However, although such compositions improve upon prior work, they are still deficient in moisture barrier and continue to be prone to difficulties and limitation in biaxial orientation processes.

U.S. Pat. No. 5,175,054 which is incorporated herein by reference, teaches us the solution coating of a mixture of solution-grade EVOH containing about 80% of vinyl alcohol and aqueous dispersion-grade of the ionomer of the alkali salt of ethylene-methacrylic acid copolymer. This coating is applied to an oriented polymer substrate and subsequently metallized. However, this composition does not incorporate nylon nor does the ionomer used contain nylon.

U.S. Pat. No. 5,153,074 which is incorporated herein by reference, reveals a metallized OPP film having the aluminum on the EVOH layer. It is known that EVOH is relatively hard to stretch compared to polypropylene. Consequently, only limited grades of EVOH like the one with 48% mole of ethylene can be co-processed with OPP without forming any surface defects. Using lower ethylene mole % EVOH (e.g. 44% or 38%) in biaxial orientation causes surface defects like stress fractures or process issues like film breaks due to the higher crystallinity of the EVOH.

World Patent application WO 02/45958 which is incorporated herein by reference, teaches us a multilayer film with a barrier layer of EVOH/nylon blends of 30 to 45 weight % of nylon. However, the DuPont literature also teaches us that the barrier properties of EVOH deteriorate significantly if the weight % of nylon in the blends is greater than 30.

Thus, the objective of this invention is to provide metallized polypropylene multi-layer films with a polar skin to enhance barrier and printing properties. Another objective is to provide biaxially oriented polypropylene multi-layer barrier films with improved stretchability and properties. Additionally, a further objective is to allow the use of EVOH copolymers which have less than 48 mole % ethylene content in biaxially oriented films without the attendant processing and appearance defect problems.

### SUMMARY OF THE INVENTION

One embodiment of this invention relates to a biaxially oriented laminate film comprising a first skin layer comprising a blend of ethylene vinyl alcohol copolymer and substantially amorphous nylon; and a core layer comprising a blend of polypropylene resin and an adhesion promoting resin that promotes adhesion between said blend and said polypropylene resin.

Another embodiment relates to a biaxially oriented laminate film comprising a first skin layer comprising a blend of ethylene vinyl alcohol copolymer and substantially amorphous nylon; a core layer comprising polypropylene resin; an intermediate layer between the first skin layer and the core layer, the intermediate layer comprising an adhesion promoting resin that promotes adhesion between said blend and said polypropylene resin.

Yet another embodiment relates to a biaxially oriented laminate film comprising a first skin layer comprising a blend of ethylene vinyl alcohol copolymer and a composition comprising nylon and an ionomer; and a core layer comprising a blend of polypropylene resin and an adhesion promoting resin that promotes adhesion between said blend and said polypropylene resin.

A final embodiment relates to a biaxially oriented laminate film comprising a first skin layer comprising a blend of ethylene vinyl alcohol copolymer and a composition comprising nylon and an ionomer; a core layer comprising polypropylene resin; an intermediate layer between the first skin layer and the core layer, the intermediate layer comprising an adhesion promoting resin that promotes adhesion between said blend and said polypropylene resin.

Preferably, the ethylene content of said ethylene vinly alcohol copolymer is from 32 to 48 mole %. Preferably, the core layer comprises 50-99 weight percent of polypropylene and 1-50% of said adhesion promoting resin. Preferably, the adhesion promoting resin is selected from carboxylic acid modified polyolefins. Preferably, the substantially amorphous nylon is 5-30 weight percent of the first skin layer. Preferably, a content of said composition comprising nylon and an ionomer of the first skin layer is 5-30 weight percent of the first skin layer.

In one variation, the laminate film further comprises a second skin layer with the core layer between the first and second skin layers. Preferably, the second skin layer comprises a winding layer comprising polypropylene resin and inorganic antiblocking agents. Preferably, the winding layer is discharge treated to provide a surface for lamination or coating with adhesives or inks. Preferably, the second skin layer comprises a matte layer of a block copolymer blend of polypropylene and one or more other polymers having a roughened surface. Preferably, the winding layer comprises an antiblock component selected from the group consisting of amorphous silicas, aluminosilicates, sodium calcium aluminum silicate, a crosslinked silicone polymer, polymethylmethacrylate and mixtures thereof. Preferably, the intermediate layer comprises carboxylic acid modified polyolefins. Preferably, the first skin layer has a discharge-treated surface. More preferably, the discharge-treated surface is formed in an atmosphere of CO₂ and N₂. In one variation, a metal layer is on the discharge-treated surface. Preferably, the metal layer has a thickness of about 5 to 100 nm. Preferably, the metal layer has an optical density of about 1.5 to 5.0. Preferably, the metal layer comprises aluminum.

In one variation, the second skin layer comprises a heat sealable polyolefin resin selected from the group consisting of a polypropylene copolymer, a polypropylene terpolymer, polyethylene, a polyethylene copolymer and mixtures thereof. In another variation, the heat sealable layer comprises an antiblock component selected from the group consisting of amorphous silicas, aluminosilicates, sodium calcium aluminum silicate, a crosslinked silicone polymer, and polymethylmethacrylate. The composition comprising nylon and an ionomer could be a copolymer of nylon and an ionomer or a physical blend of nylon and an ionomer. The nylon is preferably substantially amorphous nylon.

Additional advantages of this invention will become readily apparent to those skilled in this art from the following detailed description, wherein only the preferred embodiments of this invention is shown and described, simply by way of illustration of the best mode contemplated for carrying out this invention. As will be realized, this invention and its details are capable of modifications in various obvious respects, all without departing from this invention. Accordingly, the drawings and description are to be regarded as illustrative in nature and not as restrictive.

### DETAILED DESCRIPTION OF THE INVENTION

This invention relates to a biaxially oriented laminate film that provides improved flat sheet barrier and barrier durability of biaxially oriented metallized films resulting in a metallized high barrier packaging film with good barrier properties. The invention helps solve the problem associated with the prior art of surface defects, processability issues, and limitations of using lower ethylene content EVOH in biaxial orientation. Additionally, this invention allows the use of lower ethylene content EVOHs to be used in biaxial orientation. The ability to use lower ethylene content EVOH can further improve gas barrier properties. It is well known in the industry that biaxially oriented polypropylene-based films which have attempted to use EVOH with less than 48 mole % ethylene content are very prone to cracking or forming network structures under biaxial orientation stretching conditions, giving films with poor appearance and poor gas barrier properties. By blending 44 mole % or 38 mole % ethylene content EVOH with a certain amount of amorphous nylon or nylon-containing ionomer, this deficiency can be overcome and oriented polypropylene films can be made without such defects as cracks or network structures, thus maintaining aesthetic features and appearance as well as superior gas barrier performance.

The laminate film of the invention includes at least a 2-layer coextruded film and a metal layer, preferably a vapor deposited aluminum layer, with at least an optical density of about 1.5, preferably with an optical density of about 2.0 to 4.0, and even more preferably between 2.3 and 3.2. The core layer is a blend of homopolymer propylene and an adhesion promoting resin such as a maleic anhydride-grafted polypropylene. The amount of adhesion promoting resin is 20-30% by weight of the core layer; the amount of homopolymer propylene is 70-80% by weight of the core layer. The polar skin layer coextruded on one side of the core layer is a blend of EVOH and amorphous nylon or nylon-containing ionomer resin. The amount of amorphous nylon or nylon-containing ionomer resin is 10-30% by weight of the polar layer; the amount of EVOH is 70-90% by weight of the polar layer. This polar layer can be treated by corona discharge or flame treatment methods to enhance adhesion of the metal.

Optionally, the adhesive promoting material can be coextruded as a separate layer on one side of the core layer in which case the adhesive promoting layer is 100% of the adhesive promoting material; the polar skin layer would then be coextruded as a separate layer over the adhesion promoting layer.

Optionally, an additional layer of a heat sealable surface or a winding surface containing antiblock and/or slip additives for good machinability and low coefficient of friction (COF) can be disposed on the opposite side of the propylene homopolymer/adhesion promoting resin blend core layer. Additionally, if the third layer is used as a winding surface, its surface may also be modified with a discharge treatment to make it suitable for laminating or converter applied adhesives and inks.

In one embodiment of the invention, the laminate film comprises: an isotactic polypropylene resin core layer blended with an adhesion promoting resin, preferably an anhydride-grafted polypropylene or ethylene-propylene copolymer, at a blend ratio of 10-50% adhesion promoting resin, preferably at a blend ratio of 15-40% adhesion promoting resin, and more preferably at 20-30% adhesion promoting resin; a heat sealable layer or a non-heat sealable, winding layer coextruded onto one side of said core layer; and a polar skin layer blend coextruded on the opposite side of said core layer. This polar skin layer also provides a suitable surface for vapor deposition of metal (aka metal adhesion layer). The polar skin layer comprises a blend of EVOH and an amorphous nylon, at a blend ratio of 10-50% nylon component to EVOH, preferably 10-40% nylon component to EVOH, and more preferably 20-30% amorphous nylon component to EVOH. The EVOH is preferably 32-48 mole % ethylene, and more preferably 38-48 mole % ethylene.

In a second embodiment of the invention, the laminate film comprises: an isotactic polypropylene resin core layer blended with an adhesion promoting resin, preferably an anhydride-grafted polypropylene or ethylene-propylene copolymer, at a blend ratio of 10-50% adhesion promoting resin, preferably at a blend ratio of 15-40% adhesion promoting resin, and more preferably at 20-30% adhesion promoting resin; a heat sealable layer or a non-heat sealable, winding layer coextruded onto one side of said core layer; and a polar skin layer blend coextruded on the opposite side of said core layer. This polar skin layer also provides a suitable surface for vapor deposition of metal (aka metal adhesion layer). The polar skin layer comprises a blend of EVOH and a nylon-containing ionomer resin, at a blend ratio of 10-50% nylon-containing ionomer component to EVOH, preferably 10-40% nylon-containing ionomer component to EVOH, and more preferably 20-30% nylon-containing ionomer component to EVOH. The EVOH is preferably 32-48 mole % ethylene, and more preferably 38-48 mole % ethylene.

The polypropylene core resin layer is a crystalline polypropylene of a specific isotactic content and can be uniaxially or biaxially oriented. Crystalline polypropylenes are generally described as having an isotactic content of about 90% or greater. Suitable examples of crystalline polypropylenes for this invention are Fina 3270 and ExxonMobil PP4772. These resins also have melt flow rates of about 0.5 to 5 g/10 min, a melting point of about 163-167° C., a crystallization temperature of about 108-126° C., a heat of fusion of about 86-110 J/g, a heat of crystallization of about 105-111 J/g, and a density of about 0.90-0.91.

The core resin layer also includes an amount of anhydride-grafted polypropylene or anhydride-grafted ethylene-propylene copolymer as an adhesion promoting resin for the polar skin layer. Favorable amounts of this adhesion promoting resin is 10-50% by weight of the core layer, preferably at a blend ratio of 15-40% adhesion promoting resin, and more preferably at 20-30% adhesion promoting resin. Suitable adhesion promoting resin resin grades are those such as DuPont Bynel 3861 anhydride-grafted polypropylen, Mitsui Admer QF500 anhydride-grafted polypropylene, Admer QF551A, anhydride-grafted ethylene-propylene copolymer, and Admer AT777A, anhydride-grafted polypropylene and EP copolymer without rubber contents.

The core resin layer is typically 5 μm to 50 μm in thickness after biaxial orientation, preferably between 10 μm and 25 μm, and more preferably between 12.5 μm and 17.5 μm in thickness.

The polar resin skin layer is a blend of EVOH of 32-48 mole % ethylene, preferably 38-48 mole % EVOH, and amorphous nylon or nylon-containing ionomer. Blend ratios are 10-50% by weight of the polar skin layer of amorphous nylon or nylon-containing ionomer component to EVOH, preferably 10-40% amorphous nylon or nylon-containing ionomer component to EVOH, and more preferably 20-30% amorphous nylon or nylon-containing ionomer component to EVOH.

Suitable EVOH grades are those such as Evalca G156 (48 mole % ethylene content), Evalca E105 (44 mole % ethylene content, and Evalca H171 (38 mole % ethylene content).

Suitable grades of amorphous nylon are those such as DuPont Selar PA2072. Suitable grades of nylon-containing ionomer are those such as DuPont Surlyn AD1014.

Additionally, a small amount of inorganic antiblocking agent may be optionally added up to 1000 ppm to this polar skin resin layer. Preferably 300-500 ppm of antiblock may be added. Suitable antiblock agents comprise those such as inorganic silicas, sodium calcium aluminosilicates, crosslinked silicone polymers such as polymethylsilsesquioxane, and polymethylmethacrylate spheres. Typical useful particle sizes of these antiblocks range from 1-12 um, preferably in the range of 2-5 um.

The polar skin resin layer is coextruded with the polypropylene/anyhydride-grafted polypropylene blend core layer. The polar skin resin layer has a thickness between 0.2 and 2 μm, preferably between 0.5 and 1.5 μm, more preferably 1 um, after biaxial orientation. A heat sealable layer or non-heat sealable layer may be coextruded with the core layer opposite the polar resin layer having a thickness after biaxial orientation between 0.2 and 5 μm, preferably between 0.6 and 3 μm, and more preferably between 0.8 and 1.5 μm. The heat sealable layer may contain an anti-blocking agent and/or slip additives for good machinability and a low coefficient of friction in about 0.05-0.5% by weight of the heat-sealable layer. The heat sealable layer will be a copolymer of propylene, either ethylene-propylene or butylene-propylene, and preferably comprise a ternary ethylene-propylene-butene copolymer. If the invention comprises a non-heat sealable, winding layer, this layer will comprise a crystalline polypropylene with anti-blocking and/or slip additives or a matte layer of a block copolymer blend of polypropylene and one or more other polymers whose surface is roughened during the film formation step so as to produce a matte finish on the winding layer. Preferably, the surface of the winding layer is discharge-treated to provide a functional surface for lamination or coating with adhesives and/or inks.

The coextrusion process includes a three-layered compositing die. The polymer core layer is sandwiched between the polar resin layer and the heat sealable or winding layer. The three layer laminate sheet is cast onto a cooling drum whose surface temperature is controlled between 20° C. and 60° C. to solidify the non-oriented laminate sheet. The non-oriented laminate sheet is stretched in the longitudinal direction at about 135 to 165° C. at a stretching ratio of about 4 to about 5 times the original length and the resulting stretched sheet is cooled to about 15° C. to 50° C. to obtain a uniaxially oriented laminate sheet. The uniaxially oriented laminate sheet is introduced into a tenter and preliminarily heated between 130° C. and 180° C., and stretched in the transverse direction at a stretching ratio of about 7 to about 12 times the original length and then heat set to give a biaxially oriented sheet. The biaxially oriented film has a total thickness between 6 and 40 μm, preferably between 10 and 20 μm, and most preferably between 12 and 18 μm.

The polar resin skin layer can be surface treated with either a corona-discharge method, flame treatment, atmospheric plasma, or corona discharge in a controlled atmosphere of nitrogen, carbon dioxide, or a mixture thereof. The latter treatment method in a mixture of CO₂ and N₂ is preferred. This method of discharge treatment results in a treated surface that comprises nitrogen-bearing functional groups, preferably 0.3% or more nitrogen in atomic %, and more preferably 0.5% or more nitrogen in atomic %. This treated core layer can then be metallized, printed, coated, or extrusion or adhesive laminated. A preferred embodiment is to metallize the treated surface of the polar resin layer. The treated laminate sheet is then wound in a roll. The roll is placed in a metallizing chamber and the metal was vapor-deposited on the discharge treated polyolefin resin layer surface. The metal film may include titanium, vanadium, chromium, maganese, iron, cobalt, nickel, copper, zinc, aluminum, gold, or palladium, the preferred being aluminum. The metal layer shall have a thickness between 5 and 100 nm, preferably between 20 and 80 nm, more preferably between 30 and 60 nm; and an optical density between 1.5 and 5.0, preferably between 2.0 and 4.0, more preferably between 2.3 and 3.2. The metallized film is then tested for oxygen and moisture permeability, optical density, metal adhesion, and film durability.

This invention will be better understood with reference to the following examples, which are intended to illustrate specific embodiments within the overall scope of the invention.

### EXAMPLE 1

A 3-layer coextrusion article comprises a core layer of a blend of polypropylene and adhesion promoting resin, one skin layer of polar resin on the cast roll side, and the opposite skin layer of a terpolymer sealant on the air knife side. The total thickness of the film after biaxial orientation is 70-100 G or 0.7-1.0 mil. The thickness of the respective polar and sealant skin layers after biaxial orientation is 3-5 G and 4-6 G. The core is a 70/30 blend of polypropylene and adhesion promoting resin, melt extruded at 450-550° F. where the propylene homopolymer is Fina 3270 and Mitsui Admer QF500A maleic andhydride-grafted polypropylene as the adhesion promoting resin. The polar skin is a 70/30 blend of EVOH and amorphous nylon melt extruded at 380-450° F. where the EVOH is Evalca G156 (48 mole % ethylene) and the amorphous nylon is Dupont Selar PA2072. The sealant skin is melt extruded at 400-480° F. and is a terpolymer sealant such as Sumitomo SPX78H8. The 3-layer coextrudate was passed through a flat die to be cast on a chill drum of 100-180° F. The formed cast sheet was passed through a series of heated rolls at 210-270° F. with differential speeds to stretch in the machine direction (MD) from 4 to 6 stretch ratio, followed by transverse direction (TD) stretchin from 8 to 10 stretch ratio in the tenter oven at 310-350° F. The resultant clear film was then metallized by vapor deposition of aluminum under vacuum and tested for properties.

### EXAMPLE 2

A process similar to Example 1 was repeated except that the blend ratio of the polar skin was changed to 90% EVOH and 10% amorphous nylon.

### EXAMPLE 3

A process similar to Example 1 was repeated except that the composition of the polar skin was changed to 70% EVOH and 30% Surlyn AD1014.

### EXAMPLE 4

A process similar to Example 1 was repeated except that the composition of the polar skin was changed to 80% Evalca E105 (44 mole % ethylene) and 20% Surlyn AD1014 and the core layer polypropylene was changed to ExxonMobil PP4772.

### EXAMPLE 5

A process similar to Example 1 was repeated except that the composition of the polar skin was changed to 80% Evalca E105 (44 mole % ethylene) and 20% Selar PA2072 and the core layer was changed to 80% ExxonMobil PP4772 and 20% Admer AT777A.

### EXAMPLE 6

A process similar to Example 1 was repeated except that the composition of the polar skin was changed to 80% Evalca H171 (38 mole % ethylene) and 20% Selar PA2072 and the core layer was changed to 80% Fina 3270 and 20% Admer AT777A.

### COMPARATIVE EXAMPLE 1

A process similar to Example 1 was repeated except that a propylene homopolymer skin layer (Fina 3576X) was used instead of a polar skin layer and no adhesion promoting resin was used in the core layer.

### COMPARATIVE EXAMPLE 2

A process similar to Example 4 was repeated except that the polar skin resin layer did not contain any Surlyn AD1014.

### COMPARATIVE EXAMPLE 3

A process similar to Example 6 was repeated except that the polar skin resin layer did not contain any Selar PA2072.

The barrier and adhesion properties of the Examples and Counter Example (“CEx.”) are shown in Table 1.

TABLE 1

| | | | O2TR* | O2TR* | Adhesion | |
|---|---|---|---|---|---|---|
| Example | Polar Skin | Core Layer | Clear | Met. Film | % peel-off | Appearance |
| 1 | 70%/30% | 70%/30% | 150 | 0.77 | 0 | Good |
| | Evalca G156/Selar PA2072 | Fina 3270/Admer QF500A | | | | |
| 2 | 90%/10% | 70%/30% | 55 | 0.47 | 0 | Good |
| | Evalca G156/Selar PA2072 | Fina 3270/Admer QF500A | | | | |
| 3 | 70%/30% | 70%/30% | 76 | 0.77 | 0 | Good |
| | Evalca G156/Surlyn AD1014 | Fina 3270/Admer QF500A | | | | |
| 4 | 80%/20% | 70%/30% | 38 | 0.50 | 0 | Good |
| | Evalca E105/Surlyn AD1014 | ExxonMobil 4772/Admer QF500A | | | | |
| 5 | 80%/20% | 80%/20% | 129 | 0.67 | 0 | Good |
| | Evalca E105/Selar PA2072 | ExxonMobil 4772/Admer AT777A | | | | |
| 6 | 80%/20% | 80%/20% | 26.5 | 0.52 | 20 | Fair |
| | Evalca H171/Selar PA2072 | Fina 3270/Admer AT777A | | | | |
| CEx. 1 | 100% Fina 3576X | 100% Fina 3270 | >2000 | 25 | 0 | Good |
| CEx. 2 | 100% Evalca E105 | 70%/30% | >500 | NA | 90 | Poor |
| | | ExxonMobil 4772/Admer QF500A | | | | (cracks) |
| CEx. 3 | 100% Evalca H171 | 80%/20% | >540 | NA | 90 | Poor |
| | | Fina 3270/Admer AT777A | | | | (cracks) |

*O2TR in cc/m²/day at 38° C./0% RH

The resultant clear film of Example 1 provides good oxygen barrier with O2TR of 150 cc/m²/day versus over 2000 cc/m²/day for a typical OPP film without the polar skin layer. The metallized film of Example 1 also exhibits excellent oxygen barrier of 0.77 cc/m²/day versus 25 cc/m²/day for Counter Example 1. Similarly, Examples 2 and 3 show also show similar results as Example 1, with Example 2 showing better results than Examples 1 and 3 due to a higher proportion of EVOH in the polar skin layer. Furthermore, the adhesion of the polar skin layer to the core layer is good, equivalent to that of Counter Example 1.

Examples 4, 5, and 6 show the ability to make OPP films using lower ethylene content EVOH (44 and 38 mole % respectively) successfully without the notorious issues of poor appearance and loss of adhesion and barrier properties due to cracking of the EVOH layer typically seen due to orientation stresses. Blending these lower ethylene content EVOH's with amorphous nylon or nylon-containing ionomer significantly improves the appearance, barrier properties, adhesion properties as compared to making the film without the amorphous nylon or nylon-containing ionomer as shown in Comparative Examples 2 and 3.

The various properties in the above examples were measured by the following methods:

a. Oxygen transmission rate of the film was measured by using a Mocon Oxtran 2/20 unit substantially in accordance with ASTM D3985. In general, the preferred value was an average value equal to or less than 15.5 cc/m²/day with a maximum of 46.5 cc/m²/day.

b. Moisture transmission rate of the film was measured by using a Mocon Permatran 3/31 unit measured substantially in accordance with ASTM F1249. In general, the preferred value was an average value equal to or less than 0.155 g/m²/day with a maximum of 0.49 g/m²/day.

c. Optical density was measured using a Tobias Associates model TBX transmission densitometer. Optical density is defined as the amount of light reflected from the test specimen under specific conditions. Optical density is reported in terms of a logarithmic conversion. For example, a density of 0.00 indicates that 100% of the light falling on the sample is being reflected. A density of 1.00 indicates that 10% of the light is being reflected; 2.00 is equivalent to 1%, etc.

d. Polar skin adhesion was measured by adhering a strip of 1-inch wide 610 tape to the polar skin surface of a single sheet of film and removing the tape from the surface. The amount of polar skin removed was rated qualitatively as follows:
Good=0-10% metal removed
Fair=11-30% metal removed
Poor=>30% metal removed
In general, preferred values were Good to Fair.

Appearance was rated qualitatively on the presence of cracks on the surface of the film.

Surface chemistry of the discharge-treated surface was measured using ESCA surface analysis techniques. A Physical Electronics model 5700LSci X-ray photoelectron/ESCA spectrometer was used to quantify the elements present on the sample surface. Analytical conditions used a monochromatic aluminum x-ray source with a source power of 350 watts, an exit angle of 50°, analysis region of 2.0 mm×0.8 mm, a charge correction of C—(C,H) in C 1s spectra at 284.6 eV, and charge neutralization with electron flood gun. Quantitative elements such as O, C, N were reported in atom %.

This application discloses several numerical ranges in the text and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

We claim:

1. A biaxially oriented laminate film comprising:
a) a first skin layer comprising a blend of ethylene vinyl alcohol copolymer and amorphous nylon, wherein the first skin does not contain semicrystalline or crystalline nylon; and
b) a core layer comprising a blend of polypropylene resin and an adhesion promoting resin that promotes adhesion between said blend and said polypropylene resin.

2. A biaxially oriented laminate film comprising:
a) a first skin layer comprising a blend of ethylene vinyl alcohol copolymer and amorphous nylon, wherein the first skin does not contain semicrystalline or crystalline nylon;
b) a core layer comprising polypropylene resin;
c) an intermediate layer between the first skin layer and the core layer, the intermediate layer comprising an adhesion promoting resin that promotes adhesion between said blend and said polypropylene resin.

3. A biaxially oriented laminate film comprising:
a) a first skin layer comprising a blend of ethylene vinyl alcohol copolymer and a composition comprising amorphous nylon and an ionomer, wherein the first skin does not contain semicrystalline or crystalline nylon; and
b) a core layer comprising a blend of polypropylene resin and an adhesion promoting resin that promotes adhesion between said blend and said polypropylene resin.

4. A biaxially oriented laminate film comprising:
a) a first skin layer comprising a blend of ethylene vinyl alcohol copolymer and a composition comprising amorphous nylon and an ionomer, wherein the first skin does not contain semicrystalline or crystalline nylon;
b) a core layer comprising polypropylene resin;
c) an intermediate layer between the first skin layer and the core layer, the intermediate layer comprising an adhesion promoting resin that promotes adhesion between said blend and said polypropylene resin.

5. The laminate film according to claim 1, wherein the ethylene content of said ethylene vinly alcohol copolymer is from 32 to 48 mole %.

6. The laminate film according to claim 1, wherein said core layer comprises 50-99 weight percent of polypropylene and 1-50% of said adhesion promoting resin.

7. The laminate film according to claim 1, wherein said adhesion promoting resin is selected from carboxylic acid modified polyolefins.

8. The laminate film according to claim 1, wherein said amorphous nylon is 5-30 weight percent of the first skin layer.

9. The laminate film according to claim 1, wherein a content of said composition comprising nylon and an ionomer of the first skin layer is 5-30 weight percent of the first skin layer.

10. The laminate film according to claim 1, further comprising a second skin layer with the core layer between the first and second skin layers.

11. The laminate film according to claim 10, wherein the second skin layer comprises a winding layer comprising polypropylene resin and inorganic antiblocking agents.

12. The laminate film of claim 11, wherein said winding layer is discharge treated to provide a surface for lamination or coating with adhesives or inks.

13. The laminate film of claim 10, wherein the second skin layer comprises a matte layer of a block copolymer blend of polypropylene and one or more other polymers having a roughened surface.

14. The laminate film of claim 11, wherein said winding layer comprises an antiblock component selected from the group consisting of amorphous silicas, aluminosilicates, sodium calcium aluminum silicate, a crosslinked silicone polymer, polymethylmethacrylate and mixtures thereof.

15. The laminate film of claim 2, wherein the intermediate layer comprises carboxylic acid modified polyolefins.

16. The laminate film claim 1, wherein said first skin layer has a discharge-treated surface.

17. The laminate film of claim 16, wherein said discharge-treated surface is formed in an atmosphere of CO₂ and N₂.

18. The laminate film of claim 16, wherein a metal layer is on the discharge-treated surface.

19. The laminate film of claim 18, wherein said metal layer has a thickness of about 5 to 100 nm.

20. The laminate film of claim 18, wherein said metal layer has an optical density of about 1.5 to 5.0.

21. The laminate film of claim 18, wherein said metal layer comprises aluminum.

22. The laminate film of claim 10, wherein the second skin layer comprises a heat sealable polyolefin resin selected from the group consisting of a polypropylene copolymer, a polypropylene terpolymer, polyethylene, a polyethylene copolymer and mixtures thereof.

23. The laminate film of claim 22, wherein said heat sealable layer comprises an antiblock component selected from the group consisting of amorphous silicas, aluminosilicates, sodium calcium aluminum silicate, a crosslinked silicone polymer, and polymethylmethacrylate.

24. The laminate film of claim 3, wherein the composition comprising nylon and an ionomer is a copolymer of nylon and an ionomer or a physical blend of nylon and an ionomer.

25. The laminate film of claim 3, wherein said nylon is amorphous nylon.
